(19) United States
(12) Patent Application Publication
(10) Pub. No.: US 2026/0230397 A1
(43) Pub. Date: Aug. 6, 2026

(54) TRAINING A REINFORCEMENT LEARNING AGENT

(71) Applicant: Telefonaktiebolaget LM Ericsson (publ), Stockholm (SE)

(72) Inventors: Athanasios KARAPANTELAKIS, Voula (GR); Konstantinos VANDIKAS, Solna (SE); Marin ORLIC, BROMMA (SE); Lackis ELEFTHERIADIS, Valbo (SE)

(73) Assignee: Telefonaktiebolaget LM Ericsson (publ), Stockholm (SE)

(21) Appl. No.: 19/148,550

(22) PCT Filed: Jul. 20, 2023
(86) PCT No.: PCT/EP2023/070110

§ 371 Date: Jul. 16, 2025

(30) Foreign Application Priority Data
Feb. 6, 2023 (GR) 20230100092

(51) Int. Cl. H04L 41/16; G06N 3/092; H04L 41/0816; H04L 47/127; H04W 24/02

(52) U.S. Cl. CPC H04L 41/16; G06N 3/092; H04L 41/0816; H04L 47/127; H04W 24/02

(57) ABSTRACT

A computer implemented method performed by a first network node in a communications network for training a first agent to select an action in order to perform a task according to a Reinforcement Learning, RL, process. The method comprises: i) determining a first action using the first agent, based on a first state in the communications network, ii) sending the first action and the first state to a second network node having a second agent, iii) receiving from the second network node, feedback based on output from the second agent, on taking the first action when the communications network is in the first state, and iv) using the feedback in the training of the first agent.

### TECHNICAL FIELD

This disclosure relates to methods, nodes and systems in a communications network. More particularly but non-exclusively, the disclosure relates to training a first agent to select an action in order to perform a task in a Reinforcement Learning process.

### BACKGROUND

Reinforcement learning (RL) is used to solve problems in which an agent learns to take actions in an environment. In RL, an agent typically begins by trial and error, e.g., the agent tries out different actions in the environment and monitors which of these actions yield the highest reward.

When learning, RL algorithms make use of exploration strategies, wherein an agent uses trial and error, for example, according to methods such as Upper Confidence Bound or E-greedy exploration, to learn how to take the optimal action for every state of the environment. Optimality is formalized using a reward function, which, for every action an agent takes, returns a scalar as an assessment of how good the action was. In general, the more exploration an agent does (for example by taking random actions or choosing from a constrained set of actions), the higher the likelihood the agent will learn to take more optimal actions in the longer term (at least for certain states). However, increasing the number of RL iterations allocated to exploration can increase the time for learning, and can increase the probability that some actions of an agent may have a negative impact on the environment and system.

Reducing training time and increasing training efficiency of RL agents is an area of on-going research.

### SUMMARY

The specification herein relates to communications networks. There is currently interest in “cognitive” networks, whereby agents in the communications network itself can observe and act independently of humans. In the context of a cognitive network, such agents may learn, for example, to allocate radio resources to network slices dynamically, based on the predicted throughput of each of the slices in each node.

In Open Radio Access Network (ORAN) and intent-based architectures, it is expected that at least some types of agents would learn to make decisions by means of RL. The reason for this is that the environment of mobile networks is highly dynamic and driven by user equipments (UEs) exhibiting different throughput and mobility patterns spatially and temporally.

As described above, embodiments herein relate to the use of RL agents, particularly but non-exclusively in communications networks. RL agents may be used in a variety of tasks in a communications network, such as for resource allocation of network slices. In the example of resource allocation for network slices, an exploring agent may randomly choose to allocate very few resources to one or more slices while allocating more resources to others. In such cases, UEs using the slices which are allocated fewer resources than required as result of the agent's actions may experience communication service degradation or even outage.

Currently, several approaches are used to constrain exploration. One approach uses shared experiences, wherein agents are trained not only using their own data, but also other agents' data. For example, in the paper entitled: “Shared Experience Actor-Critic for Multi-Agent Reinforcement Learning” by Filippos Christianos, Lukas Schäfer, and Stefano V. Albrecht (arXiv:2006.07169), policy loss calculation is based on data of the learning agent and also on data of other agents. Such approaches consider the problem from the perspective of multiple learners, in what is known as multi-agent RL. This paper also considers that each agent has access to the policy functions of all other agents. This can be computationally expensive if every training iteration (e.g. gradient descent) involves the execution of policy functions of all other agents, and/or may not possible due to geofencing.

Another technique that can be used in cases where pre-trained agents already exist is transfer learning, where machine learning (ML) model weights are transferred from a trained agent to an untrained one. The untrained one can then be refined in fewer training iterations to reach an acceptable level of performance. A caveat is that the environments of the trained and trainee agents (also known as “domains”) must be similar for transfer learning to be successful. For example, consider an agent in a cell performing a Radio Resource Management (RRM)-related task, e.g., allocation of Physical Resource Blocks (PRBs) to UE. If a new cell is commissioned, then transfer learning of the model trained in the old cell can help the new cell accelerate the bootstrapping process by reducing the amount of training. However, if the trained cell was in a rural environment where there were few UEs and situations of radio resource shortage occurred very rarely, then it would not have been trained sufficiently to handle cases that a cell in a densely populated area (such as a city) would likely encounter. In such cases (where the environments of the respective agents are very different), transfer learning may even bias a new agent into taking inappropriate actions.

Domain adaptation techniques can help adapt a model trained in one domain (e.g. one set of feature probability value distributions) to another domain, but these approaches typically require access to the source dataset, which is compared to data obtained by the trainee agent. Data availability is not always guaranteed because in many cases (including models trained in cells) data is not stored by default, to save storage and computational resources.

In Safe RL, exploration is done according to a set of criteria with the aim of ensuring reasonable system performance while constraining the action space of exploring agents. As is discussed in the paper entitled: “A Review of Safe Reinforcement Learning: Methods, Theory and Applications”, by Shangding Gu, Long Yang, Yali Du, Guang Chen, Florian Walter, Jun Wang, Yaodong Yang, Alois Knoll (arXiv:2205.10330), two general approaches exist: a model-based approach, where the trainee agent first learns a model of the environment and acts accordingly, and a model-free approach, where the trainee agent acts by trial and error.

In the examples above, the agent providing the knowledge to the learning agent (in the form of “experiences”, “demonstrations” or model weights) is assumed to be a global authority providing ground truth, or fellow learning agents training together.

However these approaches are not optimal for many scenarios, for example, where there could be malicious agents, or where the environments of the new and experienced agents are different and the agent providing knowledge to the learning agent may not actually be an appropriate global authority in this way. There is thus a need for improved methods of training RL models that address some of the aforementioned issues.

Thus, according to a first aspect herein there is a computer implemented method performed by a first network node in a communications network for training a first agent to select an action in order to perform a task according to a Reinforcement Learning, RL, process. The method comprises i) determining a first action using the first agent, based on a first state in the communications network. In a second step the method comprises ii) sending the first action and the first state to a second network node having a second agent. In a third step the method comprises iii) receiving from the second network node, feedback based on output from the second agent, on taking the first action when the communications network is in the first state. In a fourth step the method comprises iv) using the feedback in the training of the first agent.

In some embodiments, a first score representing a measure of a quality of previous feedback received from the second agent, is used to select the second agent to receive feedback from; and/or determine whether to use the feedback in the training of the first agent. In a second aspect there is a computer implemented method performed by a second network node in a communications network for training a first agent on a first network node in the communications network to select an action in order to perform a task according to a Reinforcement Learning, RL, process. In a first step the method comprises receiving from the first network node a first state in the communications network and a first action determined by the first agent for the first state. In a second step the method comprises sending to the first node, feedback based on output from a second agent, on taking the first action when the communications network is in the first state.

In a third aspect there is a first network node in a communications network for training a first agent to select an action in order to perform a task according to a Reinforcement Learning, RL, process. The first node comprises a memory comprising instruction data representing a set of instructions and a processor configured to communicate with the memory and to execute the set of instructions. The set of instructions when executed by the processor, cause the processor to i) determine a first action using the first agent, based on a first state in the communications network. The set of instructions further cause the processor to ii) send the first action and the first state to a second network node having a second agent. The set of instructions further cause the processor to iii) receive from the second network node, feedback based on output from the second agent, on taking the first action when the communications network is in the first state. The set of instructions further cause the processor to iv) use the feedback in the training of the first agent.

According to a fourth aspect there is a second node in a communications network for training a first agent on a first network node in the communications network to select an action in order to perform a task according to a Reinforcement Learning, RL, process. The second node comprises a memory comprising instruction data representing a set of instructions and a processor configured to communicate with the memory and to execute the set of instructions. The set of instructions, when executed by the processor, cause the processor to receive from the first network node a first state in the communications network and a first action determined by the first agent for the first state, and send to the first node, feedback based on output from a second agent, on taking the first action when the communications network is in the first state.

According to a fifth aspect there is a system in a communications network for training a first agent to select an action in order to perform a task according to a Reinforcement Learning, RL, process. The system comprises a first node having the first agent, and a second node having a second agent. The first node is configured to determine a first action using the first agent, based on a first state in the communications network and send the first action and the first state to the second network node. The second network node is configured to receive from the first network node the first state in the communications network and the first action determined by the first agent for the first state and send to the first node, feedback based on output from the second agent, on taking the first action when the communications network is in the first state.

According to a sixth aspect there is a computer program comprising instructions which, when executed on at least one processor, cause the at least one processor to carry out a method according to the first or second aspects.

According to a seventh aspect there is a carrier containing a computer program according to the sixth aspect, wherein the carrier comprises one of an electronic signal, optical signal, radio signal or computer readable storage medium.

According to an eighth aspect there is a computer program product comprising non transitory computer readable media having stored thereon a computer program according to the sixth aspect.

In this manner, training of a first agent in a RL setting (“agent-trainee”) can be accelerated, utilizing the experience of a second agent which may be a pretrained agent or agent that is in the process of being trained, and not necessarily belonging to the same training loop as the first agent. Instead of transferring policy functions (e.g., ML models), or exchanging experiences such as training data (e.g., <state, action, reward, next state >4-tuples), the first agent that is being trained requests from the second agent, feedback about an action that it selects to take. The feedback comes in the form of a response to a request, that can be time-bounded but also recipient-bounded (in terms of e.g., number of recipients, or other criteria). Thus, what is proposed herein is that the agent-trainee receives feedback on an action that it proposes itself. As described below, this feedback may be used to adjust its training (such as by adjusting an exploration approach) based on the feedback. In some embodiments, the feedback is moderated according to a score associated with the second agent that measures the quality of previous feedback received from the second agent. The use of scores in this way, allows the first agent to select appropriate agents to request feedback from and/or disregard feedback from agents that have previously provided counter-productive or otherwise poor feedback, and prioritise feedback from agents that have previously provided good feedback.

### BRIEF DESCRIPTION OF THE DRAWINGS

For a better understanding and to show more clearly how embodiments herein may be carried into effect, reference will now be made, by way of example only, to the accompanying drawings, in which:

FIG. 1 shows a first node in a communications network according to some embodiments herein;

FIG. 2 shows a method in a first node in a communications network according to some embodiments herein;

FIG. 3 shows a second node in a communications network according to some embodiments herein;

FIG. 4 shows a second method in a second node in a communications network according to some embodiments herein;

FIG. 5 shows a method in a system according to some embodiments herein;

FIG. 6 shows a signal diagram according to some embodiments herein; and

FIG. 7 shows an example action space.

### DETAILED DESCRIPTION

The disclosure herein relates to a communications network (or telecommunications network). A communications network may comprise any one, or any combination of: a wired link (e.g. ASDL) or a wireless link such as Global System for Mobile Communications (GSM), Wideband Code Division Multiple Access (WCDMA), Long Term Evolution (LTE), New Radio (NR), WiFi, Bluetooth or future wireless technologies. The skilled person will appreciate that these are merely examples and that the communications network may comprise other types of links. A wireless network may be configured to operate according to specific standards or other types of predefined rules or procedures. Thus, particular embodiments of the wireless network may implement communication standards, such as Global System for Mobile Communications (GSM), Universal Mobile Telecommunications System (UMTS), Long Term Evolution (LTE), and/or other suitable 2G, 3G, 4G, or 5G standards; wireless local area network (WLAN) standards, such as the IEEE 802.11 standards; and/or any other appropriate wireless communication standard, such as the Worldwide Interoperability for Microwave Access (WiMax), Bluetooth, Z-Wave and/or ZigBee standards.

It is noted that the communications network may be a real-world communications network. Alternatively, the communications network may be a simulated communications network, for example, a digital twin of a real-world communications network as implemented by a network simulator.

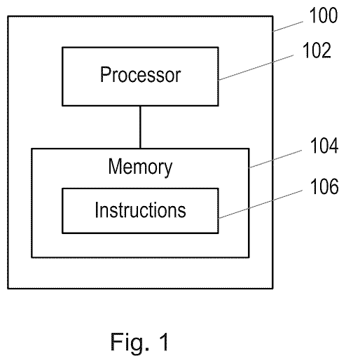

FIG. 1 illustrates a first network node 100 in a communications network according to some embodiments herein. Generally, the node 100 may comprise any component or network function (e.g. any hardware or software module) in the communications network suitable for performing the functions described herein.

The node 100 is configured (e.g. adapted, operative, or programmed) to perform any of the embodiments of the method 200 as described below. It will be appreciated that the node 100 may comprise one or more virtual machines running different software and/or processes. The node 100 may therefore comprise one or more servers, switches and/or storage devices and/or may comprise cloud computing infrastructure or infrastructure configured to perform in a distributed manner, that runs the software and/or processes.

The node 100 may comprise a processor (e.g. processing circuitry or logic) 102. The processor 102 may control the operation of the node 100 in the manner described herein. The processor 102 can comprise one or more processors, processing units, multi-core processors or modules that are configured or programmed to control the node 100 in the manner described herein. In particular implementations, the processor 102 can comprise a plurality of software and/or hardware modules that are each configured to perform, or are for performing, individual or multiple steps of the functionality of the node 100 as described herein.

The node 100 may comprise a memory 104. In some embodiments, the memory 104 of the node 100 can be configured to store program code or instructions 106 that can be executed by the processor 102 of the node 100 to perform the functionality described herein. Alternatively or in addition, the memory 104 of the node 100, can be configured to store any requests, resources, information, data, signals, or similar that are described herein. The processor 102 of the node 100 may be configured to control the memory 104 of the node 100 to store any requests, resources, information, data, signals, or similar that are described herein.

It will be appreciated that the node 100 may comprise other components in addition or alternatively to those indicated in FIG. 1. For example, in some embodiments, the node 100 may comprise a communications interface. The communications interface may be for use in communicating with other nodes in the communications network, (e.g. such as other physical or virtual nodes). For example, the communications interface may be configured to transmit to and/or receive from other nodes or network functions requests, resources, information, data, signals, or similar. The processor 102 of node 100 may be configured to control such a communications interface to transmit to and/or receive from other nodes or network functions requests, resources, information, data, signals, or similar.

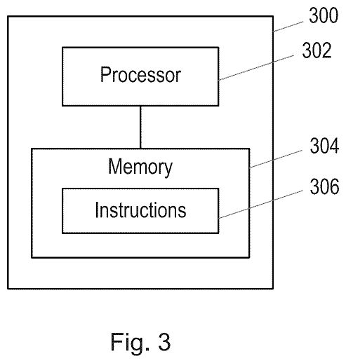

FIG. 3 shows a second node 300 in a communications network. Generally, the node 300 may comprise any component or network function (e.g. any hardware or software module) in the communications network suitable for performing the functions described herein.

The node 300 is configured (e.g. adapted, operative, or programmed) to perform any of the embodiments of the method 400 as described below. It will be appreciated that the node 300 may comprise one or more virtual machines running different software and/or processes. The node 300 may therefore comprise one or more servers, switches and/or storage devices and/or may comprise cloud computing infrastructure or infrastructure configured to perform in a distributed manner, that runs the software and/or processes.

The node 300 may comprise a processor (e.g. processing circuitry or logic) 302. The second node 300 may further comprise a memory 304. In some embodiments, the memory 304 of the node 300 can be configured to store program code or instructions 306 that can be executed by the processor 302 of the node 300 to perform the functionality described herein. Processors, memories and instructions were all described above with respect to the first node 100 and the detail therein will be understood to apply equally to the second node 300.

Generally, the methods described herein may be performed by any nodes in a communications network. Some examples are as follows.

The first node and/or the second node may comprise equipment capable, configured, arranged and/or operable to communicate directly or indirectly with a UE (such as a wireless device) and/or with other network nodes or equipment in the communications network to enable and/or provide wireless or wired access to the UE and/or to perform other functions (e.g., administration) in the communications network. Examples of such nodes include, but are not limited to, access points (APs) (e.g., radio access points), base stations (BSs) (e.g., radio base stations, Node Bs, evolved Node Bs (eNBs) and NR NodeBs (gNBs)). Further examples of nodes include but are not limited to core network functions such as, for example, core network functions in a Fifth Generation Core network (5GC).

In other embodiments, the first node and/or the second node may be a User Equipment (UE). A UE may comprise a device capable, configured, arranged and/or operable to communicate wirelessly with network nodes and/or other wireless devices. Unless otherwise noted, the term UE may be used interchangeably herein with wireless device (WD). Communicating wirelessly may involve transmitting and/or receiving wireless signals using electromagnetic waves, radio waves, infrared waves, and/or other types of signals suitable for conveying information through air. In some embodiments, a UE may be configured to transmit and/or receive information without direct human interaction. For instance, a UE may be designed to transmit information to a network on a predetermined schedule, when triggered by an internal or external event, or in response to requests from the network. Examples of a UE include, but are not limited to, a smart phone, a mobile phone, a cell phone, a voice over IP (VOIP) phone, a wireless local loop phone, a desktop computer, a personal digital assistant (PDA), a wireless cameras, a gaming console or device, a music storage device, a playback appliance, a wearable terminal device, a wireless endpoint, a mobile station, a tablet, a laptop, a laptop-embedded equipment (LEE), a laptop-mounted equipment (LME), a smart device, a wireless customer-premise equipment (CPE). a vehicle-mounted wireless terminal device, etc. A UE may support device-to-device (D2D) communication, for example by implementing a 3GPP standard for sidelink communication, vehicle-to-vehicle (V2V), vehicle-to-infrastructure (V2I), vehicle-to-everything (V2X) and may in this case be referred to as a D2D communication device. As yet another specific example, in an Internet of Things (IoT) scenario, a UE may represent a machine or other device that performs monitoring and/or measurements, and transmits the results of such monitoring and/or measurements to another UE and/or a network node. The UE may in this case be a machine-to-machine (M2M) device, which may in a 3GPP context be referred to as an MTC device. As one particular example, the UE may be a UE implementing the 3GPP narrow band internet of things (NB-IoT) standard. Particular examples of such machines or devices are sensors, metering devices such as power meters, industrial machinery, or home or personal appliances (e.g. refrigerators, televisions, etc.) personal wearables (e.g., watches, fitness trackers, etc.). In other scenarios, a UE may represent a vehicle or other equipment that is capable of monitoring and/or reporting on its operational status or other functions associated with its operation. A UE as described above may represent the endpoint of a wireless connection, in which case the device may be referred to as a wireless terminal. Furthermore, a UE as described above may be mobile, in which case it may also be referred to as a mobile device or a mobile terminal.

The skilled person will appreciate that the examples above are non-exhaustive and that the first node and/or the second node may be comprised in other equipment or software components in, or in communication with, a communications network.

The first node has thereon (e.g. operates) a first RL agent which may be referred to herein as “the first agent”, or the “trainee agent”. The second node has thereon (e.g. operates) a second RL agent which may be referred to herein as “the second agent”, or “consultant agent”. The first and second agents may be implemented as software.

The first agent is for performing a task using a RL process. The skilled person will be familiar with RL processes, such as for example, Deep-Q Learning (and Deep-Q Learning derivatives), and Actor-Critic RL processes. These are merely examples however and it will be appreciated that the methods herein apply equally to other RL processes.

The second agent may be for performing the same task as the first agent. The second agent may have undergone more training than the first agent. For example, the second agent may have performed a higher number of exploration actions compared to the first agent, or have been operating for longer than the first agent. As such, the second agent may be more reliable than the first agent. In this sense, reliable may mean that on average, actions selected by the second agent may receive higher rewards than actions selected by the first agent. Another measure of reliability is cumulative reward. For example, the second agent may be more reliable if it has a higher cumulative reward for the previous n actions, compared to the cumulative reward of the previous n actions of the first agent. The skilled person will appreciate that these are merely examples and that the efficacy of a RL agent can equally be quantified in other ways to those described herein.

Thus, in some embodiments, (contrary to actor-critic type of approaches which assume a critic that learns at the same time as the actor (agent)), the second agent may be one of a plurality of other agents that act as “critics,” that may have already learned or are also in the process of learning, independently of the first agent.

The first agent performs the task (e.g. the first agent acts) on a first environment and obtains/makes observations of the first environment that are used as state values by the first agent to select actions. The second agent performs a task (e.g. the second agent acts on) a second environment and obtains/makes observations of the second environment that are used as state values by the second agent to select actions to perform on the second environment. The first environment may be the same as (or substantially the same as or similar to) the second environment.

The first action may comprise altering a configuration parameter in the communications network, or performing some other action to change the operation of the communications network itself.

In some embodiments, the action is to be performed by a mechanical entity interacting with a real-world environment. In such an example, the first state comprises observations of the environment. As an example, a mechanical entity may be a robot, a vehicle, machinery, sensor, or any other mechanical equipment. The real-world environment may be the location in which the mechanical entity operates, for example, a factory floor, road network, or other outdoor setting. In some embodiments, the task is related to maintenance of such a mechanical entity, wherein the observations comprise one or more alarm statuses and the action comprises a prediction of a failure status.

In some embodiments, the action is performed by an electronic entity that interacts with other electronic entities, e.g. by means of electronic signals. In such an example the electronic entities may interact with the real-world, either directly or indirectly.

As an example, the state may comprise measurements of key performance indicators, KPIs, in the communications network, the task can be related to a failure of the communication network to achieve a target KPI, and the action can comprise making a change in the operation or configuration of the communication network.

In another example,

As an example, the task may be related to prediction of congestion level in the communications network. In such an example, the state comprises measurements of key performance indicators, KPIs, in the communications network and the action comprises making a prediction of a congestion level.

As another example, the task is related to resource partitioning of network slices, the state comprises traffic volumes sent on different slices in the communications network and the action comprises selecting a manner in which to partition the spectrum.

The skilled person will appreciate however that these are merely examples and that a wide range of agents performing a wide range of different actions and tasks may be trained using the methods described herein.

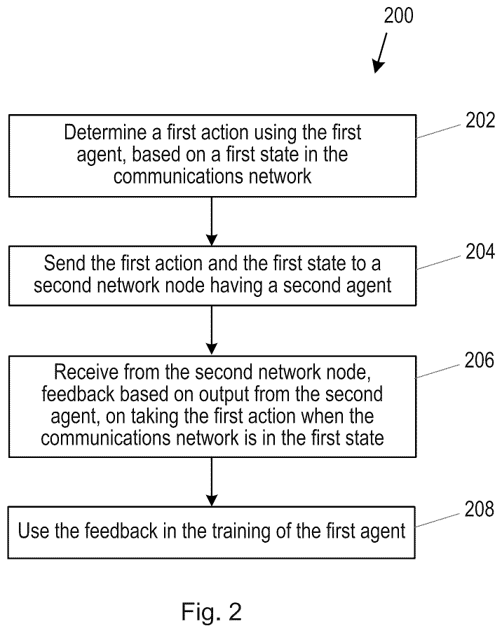

Turning to FIG. 2, briefly, as noted above, the first node 100 may be for training a first agent to select an action in order to perform the task according to a Reinforcement Learning, RL, process. The first node 100 may be configured to i) determine 202 a first action using the first agent, based on a first state in the communications network, ii) send 204 the first action and the first state to a second network node having a second agent, iii) receive 206 from the second network node, feedback based on output from the second agent, on taking the first action when the communications network is in the first state, and iv) use 208 the feedback in the training of the first agent.

In more detail, in step 202, the first agent determines a first action for the first state. As such, the first action may be considered to be an action proposed by the first agent when the environment on which it is acting is in the first state. For example, the first agent may run its policy function for the given state to determine an action, which may be denoted at. The first action may be selected according to an exploration or an exploitation strategy. When the first action is selected using exploration (e.g. a random selection from the action space), the methods 200 and 400 may be used to obtain feedback on whether the first action is a “good” action or not.

In step 204, the first agent sends, in a first message, the first state and the first action (proposed by the first agent) to a second agent on a second network node. The second network node sends feedback on the first action proposed by the first network node to the first agent on the first node and this is received 206 by the second network node and used 208 in the training of the first agent. The feedback may otherwise be referred to herein as an opinion on (taking) the first action or a rating.

In some embodiments, the second agent (on the second node) is selected, e.g from a plurality of other agents, to receive feedback from. The method 200 may thus comprise a step of selecting a second agent (from a plurality of other agents) from which to obtain feedback from. The second agent may be selected based on a first score representing a measure of quality of previous feedback received from the second agent. The first score may be otherwise referred to herein as the “reputation” of the first agent.

The plurality of other agents may all be trained (or in the process of being trained) to perform the same task as the first agent. The plurality of other agents may be operating in different environments to the first agent and, as such, their feedback may, or may not, be applicable to the first agent. As another example, there may be malicious agent(s) in the plurality of other agents. Using the scoring mechanism described herein, feedback, agents whose feedback is less applicable to the first agent (e.g. either because they are operating in different environments or because they are malicious) may not be selected to receive feedback from, or their feedback may be downgraded, or disregarded using the scoring mechanism described herein.

The first score may be calculated by performing the first action and comparing a first reward received as a result of performing the action, to the feedback from the second agent. E.g. the second agent may be deemed a reliable source of feedback if poor feedback from the second agent has been received in respect of previous actions that have resulted in low or negative rewards; or if positive feedback has from the second agent has been received in respect of previous actions that have resulted in high or positive rewards. The first score may be set based on such a comparison. For example, the first score may indicate whether the feedback received from the second agent is positively correlated with the reward received for performing the respective action.

Generally, the first score may be used to determine whether to send a subsequent (e.g. second) action and a second state to the second agent in order to obtain feedback from the second agent on taking the second action when the communications network is in the second state.

The third action and the third state may be me sent to a third agent (instead of the second agent) if a second score associated with the third agent indicated that the third agent is more likely to provide higher quality feedback than the first score associated with the second agent.

Once the second agent has been selected, then in step 204, the first action and the first state are sent in a message to the second agent on the second network node. It will be appreciated that this is merely an example, and that in some embodiments (or in some epochs of training), the first agent may send the first action and the first state to all available agents to receive feedback from them all. In other embodiments (or in some epochs of training), the first agent may send the first action and the first state to a subset of the plurality of other agents. For example, the first agent may calculate scores for each of the plurality of other agents and select a subset of the plurality of other agents to send the first action and the first state to. The subset may be selected in any manner, e.g. the agents with the top 10 scores, or the top 10 percent of scores, or in any other way.

The second agent receives the first state and the first action proposed by the first agent for the first state. The second agent then determines the feedback. The feedback may be based on a comparison between the first action (proposed by the first agent) and a third action, the third action being an action that would be selected by the second agent to perform, based on the first state in the communications network. As such, the second agent may run its policy function on the first state in order to determine the third action.

The feedback may, for example be based on a distance metric between the first action and the third action in an action space. In this sense, the action space is a multidimensional volume comprising all of the possible actions that could be selected. As an example, the distance metric may be a Euclidean distance between the first action and the third action in the action space. In this way, the distance or separation between the first and third actions may be quantified (positive feedback corresponding to smaller values of the distance metric than larger ones).

In other embodiments, the feedback may indicate whether the second agent would have selected the same action as that proposed by the first agent. E.g. whether the second agent “agrees” with the first action proposed by the first agent. As such, the feedback may indicate whether the third action determined by the second agent is the same as the first action determined by the first agent. The indication may be provided e.g. as a binary indication, or in any other manner.

In some embodiments, the feedback from the second agent further comprises a confidence value. The confidence value may indicate an extent to which the third action was determined using a policy action of the second agent, or determined by an exploration of the action space.

The skilled person will appreciate that these are merely examples, and that the feedback may be provided in other ways to that described above.

The second agent then sends the feedback to the first agent on the first node and this is received in step 206 of the method 200. In step 208 the feedback is used in the training of the first agent.

In some embodiments, the first score, described above, may be used to determine whether to use the feedback in the training of the first agent. The first score may be used alternatively or additionally in this manner. As an example, in embodiments where feedback is obtained from a subset of a plurality of other agents (as described above), scores may be calculated for each of the subset of the plurality of other agents in the same manner as was described for the first score, above. In such embodiments, in step 208, the scores may be used to determine whether feedback from one or more agents may be disregarded (and not contribute to the training of the first agent) based on the respective scores. As another example, a weighted combination of the feedback may be used, where the weights in the weighted combination are set according to the respective scores of each other agent.

Generally, in embodiments where steps i)-iii) (e.g. 202-206) are repeated for a plurality of other agents (or a subset thereof), step iv) may use an aggregation of the feedback from the plurality of agents in the training of the first agent. In this sense an aggregation may be a mean, mode, summation, or any other average, or combination of the feedback of the plurality of other agents.

The feedback may be used in different ways. As an example, the feedback may be used to set (or change) an exploration strategy of the first agent. As an example, if the feedback from the second agent (or the aggregated feedback from the plurality of other agents) is positive, then the rate of exploration of the first agent may be reduced (since the feedback indicates that the first agent made a good choice). In other words, step 208 may comprise reducing a first probability associated with the first agent selecting a subsequent action using an exploration strategy if the feedback from the second agent is positive.

Conversely, if the feedback from the second agent (or the aggregated feedback from the plurality of other agents) is negative, then the rate of exploration of the first agent may be increased (since the feedback indicates that the first agent made a poor choice and requires further training through exploration). In other words, step 208 may comprise increasing a first probability associated with the first agent selecting a subsequent action using an exploration strategy if the feedback from the second agent is negative.

Thus, in this way, the first agent receives feedback on the first action that it proposed itself, and adjusts its exploration approach accordingly.

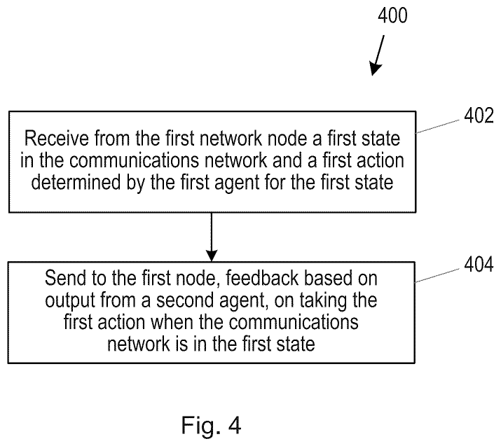

Turning now to FIG. 4, which shows a computer implemented method 400 performed by a second network node in a communications network for training a first agent on a first network node in the communications network to select an action in order to perform a task according to a Reinforcement Learning, RL, process. The second node 300 may perform the method 400 shown in FIG. 4, which has complementary steps to the method 200.

Briefly, the method 400 may comprise steps of: receiving 402 from the first network node a first state in the communications network and a first action determined by the first agent for the first state, and sending 404 to the first node, feedback based on output from a second agent, on taking the first action when the communications network is in the first state.

The first action, first state and the manner in which the second node determines feedback thereon to send to the first agent were all described in detail above with respect to the method 200 and the detail therein will be understood to apply equally to the method 400.

As noted above, it will be appreciated that more than one other agent may perform the method 400 and send feedback to the first agent.

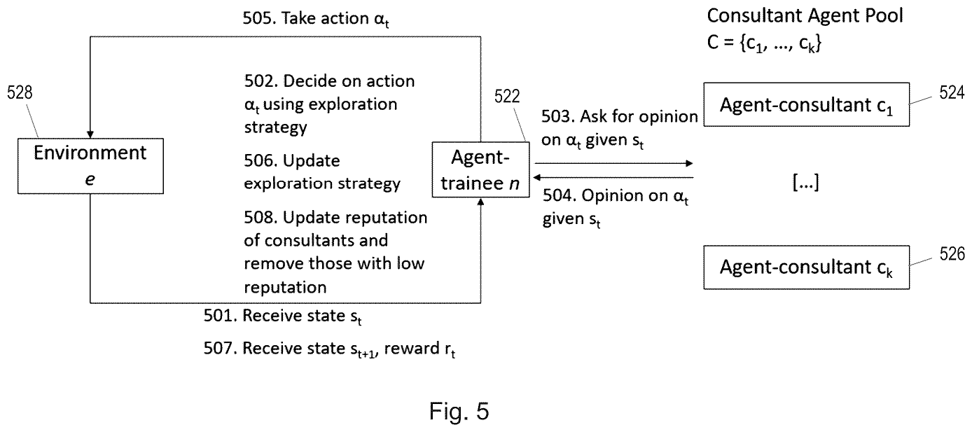

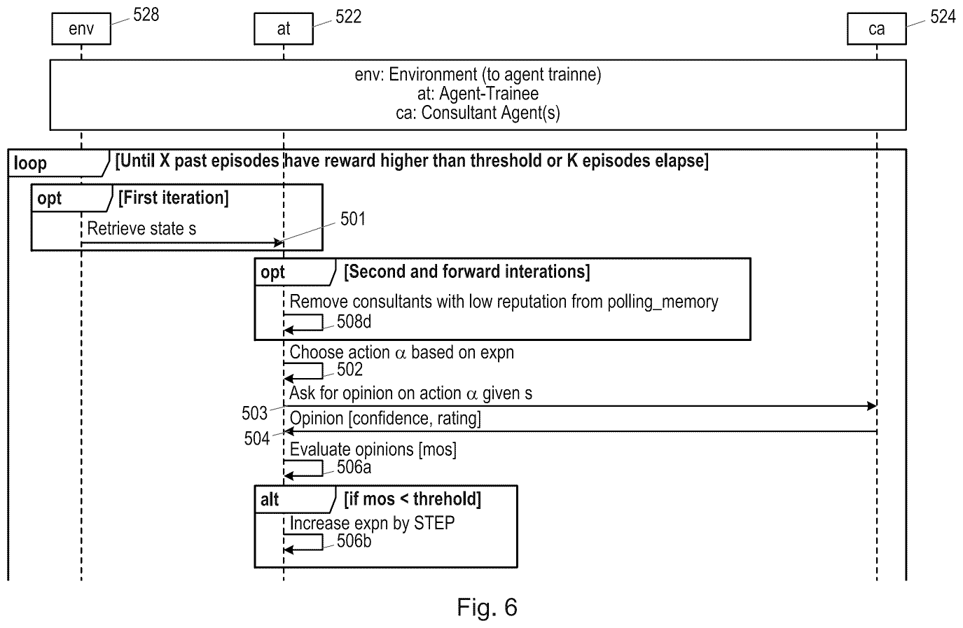

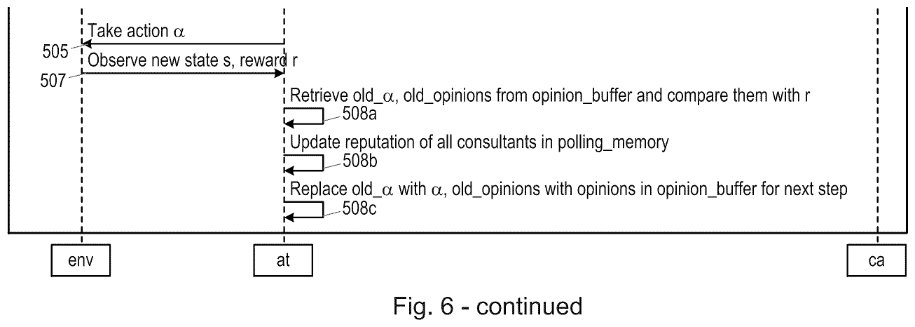

Turning now to FIG. 5, which shows an embodiment of the methods 200 and 400. In this embodiment there is a first agent 522, referred to as the “trainee agent”, a second agent 524 referred to as the Agent-Consultant, c₁ and one or more other agents 526 Agent-consultants Ck. The Agent-Consultants are either in the process of being trained, or already trained. The agent-trainee implements an RL algorithm, such as a Deep-Q Learning derivative, Actor-Critic, or other. RL algorithms train the agent-trainee to take the best action for a given state of environment e 528, i.e., the action yielding the highest reward. The algorithm flow of messages is described below and is also illustrated in the signal diagram shown in FIG. 6:
Let πn the policy learned by agent-trainee n. Depending on the algorithm, it can be a table of values, a deep neural network, a regression function, etc.
Let expn the exploration policy of agent n, which indicates current probability that the agent will explore the next state choosing e.g., a random action. Similarly, 1−expn is the probability that the agent will exploit the learned policy function Tin to produce next action.
Let polling_memory the memory holding the reputation (referred to above as a “score”) of all agents. Reputation is a scalar, i.e., a 0 to 1 normalized float indicating how reliable the agent is. In the beginning of the process all agents have the same reliability, i.e., the value can be set to 0.5, assuming the [0, 1] scale.
Let opinion_buffer the memory holding the opinion of agents of the previous state. This is used for the agent to compare those opinions to the reward, received after an agent took an action on the current state.

The steps shown in FIGS. 5 and 6 run in loops until the reward return from the environment is consecutively higher than a THRESHOLD for X number of iterations (“episodes”) or until K number of episodes have elapsed. THRESHOLD, X and K are numbers set by design.

Steps 501 and 502: The trainee agent (e.g. the first agent) receives a state s in step 501 and then, in step 502, performs step 202 of the method 200 and determines (e.g. chooses or selects) a first action, a, using exploration strategy expn. In this embodiment, the agent-trainee chooses an action based on its exploration strategy.

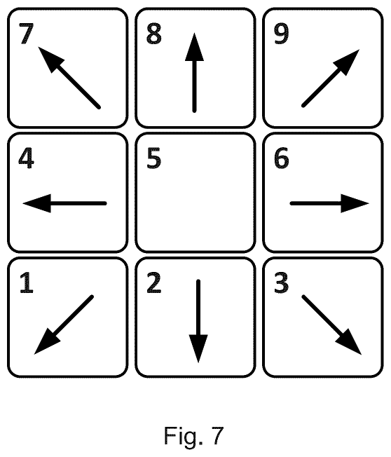

Step 503: The agent-trainee consults its polling_memory and retrieves all consultant agents (e.g. a plurality of other agents), and performs step 204 of the method 200 and requests feedback (e.g. an opinion) from the consultant agents on taking the first action a for the state s. In this embodiment, as part of the feedback/opinion each consultant agent offers a rating of the action, i.e., a scalar, that can be normalized, that indicates whether the action chosen by the agent is good or bad. In this embodiment, each consultant agent executes its policy function using s as input (e.g., a feed-forward pass in case the policy function is a feed-forward artificial neural network) and based on the result selects its own action α_{c}. It then compares its own-chosen action with the action provided by the agent-trainee.
In one embodiment, this comparison is based on whether the action chosen by the consultant agent is the same as the one chosen by trainee agent. If yes, then the rating for this agent is set to 1, if no then it is set to 0.
In another embodiment this comparison is based on the distance between αₜ and α_{c}. As distance we define a function that indicates how relevant is αₜ to α_{c}. For example, with reference to FIG. 7, there may be 9 actions of a trainee agent learning to control a robot.

Then, if action αₜ=4 and α_{c}=6, the rating is 0. However, if αₜ=9 and α_{c}=6, then rating could be higher than 0 as the robot is generally moving to the desired direction. In this example, consultant agents may have in store a table or formula that indicates the distance between action pairs across the action space.

In this embodiment, in step 504 (equivalent to step 404 described above), the consultant agent, together with the rating provides a confidence as part of the feedback/opinion, indicating the degree to which the consultant agent took the action using its policy function, or chose a random action. In the latter case, confidence is 0, whereas in the former, it can vary, depending on whether the consultant agent is also being trained or has finished training. Another factor that can affect confidence is observability. In case where all agents have full observability of the state space, then confidence is unaffected. However, in cases where agents have partial observability, meaning that they cannot observe each other's total or any “state”, then a penalty could be added to the confidence, that is either a constant or based on the overlap of observation spaces of the respective consultant agent with the trainee agent.

Step 505: the trainee agent performs the proposed action.

Step 506: The trainee-agent evaluates all the opinions of consultant agents it receives, by e.g., using mean opinion score (MOS) (shown by process 506a in FIG. 6), i.e., a weighted or non-weighed average on the ratings of all agents. As an example, in a weights approach, the weights could be dependent on the relative confidence of each agent but also the reputation. If MOS is below a threshold, then the probability for exploration is increased by STEP (as illustrated by step 506b in FIG. 6). If for example the exploration strategy is an epsilon-greedy derivative, then the value of epsilon is increased, to increase the probability of exploration. In another embodiment we can consider a different exploration strategy based on the upper confidence bound algorithm particularly for action selection.

The formula for UCB is given by

$${A}_{T} = arg {max}_{a} ( {Q}_{T} ( a ) + c \sqrt{\frac{ln ( t )}{{N}_{t} ( a )}} )$$

where Qₜ(a) is the agent's estimate for action a at time t. Based on the UCB approach, that estimate is boosted by the confidence for that action multiplied by the square root of the fraction of the number of times that action was taken.

Step 508: In each iteration, the agent-trainee stores the rating (otherwise referred to herein as the score) of each consultant agent and compares it with the reward that is returned in step 507 by the environment for at (this is shown by step 508a in FIG. 6) If there is a positive correlation between a rating of an agent and the reward (e.g., both are “1”, or close to “1”, or close to “0”), this means that the consultant agent provided a “reliable” opinion, ergo its reputation score is increased. Similarly, a reputation score can be decreased in case the consultant agent provided an unreliable opinion. The reputations (e.g. scores) of the consultant agents are updated (508b in FIG. 6) along with the actions and opinions buffers (step 508c in FIG. 6). Over time, the trainee agent filters consultant agents with low reputation by removing them from its polling_buffer (508d in FIG. 6); eventually consulting those which have the highest reputation.

In this manner, an agent-trainee can apply a selection protocol, that can be e.g., based on consensus, or majority, or preferential treatment of opinion of one or more agents, over a population of agents. Over time, the agent-trainee is guided to choose the best actions for a state by rejecting opinions of less “reliable” agents over others.

Turning now to other embodiments, as described above, the methods herein may be applied to various applications in the Radio-Access Network, RAN domain. For example, consider higher-layer intents, e.g., coming from a Network Operations Center (NOC) or an operations support system (OSS) towards the RAN and multiple agents in the RAN decomposing and handling these intents. For example, consider an agent in every Radio Base Station (RBS), e.g., gNB or eNB. Some use cases could be:

First, congestion prediction, using performance monitoring (PM) counters available to the RBS. In this case, the RBS agent learns to predict congestion using historical and current measurements for several different counters, for example, aggregate throughput, number of active UE, etc. Such counters can be considered input features, whereas the output could be, e.g., an indication of probability of congestion at time K in the future. If the prediction the RBS makes uses a classification model, then time K may be a discrete time “slot” (e.g., in the next 5 to 10 minutes). In case of a regression, then time K can be a point in time, e.g., 5 minutes and 10 seconds.

Another use case is about predictive maintenance of equipment. In this case, the RBS agent receives alarms from the baseband board, and learns to classify these alarms as a potential hardware problem. For example, receiving several potential high temperature warning alarms in short order may indicate an imminent cooling system failure. In another example, receiving lots of bit error rate alarms on radio links may indicate cable failure of the Common Public Radio Interface (CPRI).

Another use case is about resource partitioning between network slices. In this use case, spectrum resources on the downlink interface are allocated to different network slices. The RBS agent receives information with regards to volume traffic sent via different slices to UE and partition the spectrum accordingly (e.g., using a percentage or literal number of Physical Resource Blocks).

The overall advantage that this solution brings when it comes to RAN operation is twofold: First, new RBSs can be bootstrapped faster, their agents learning at a faster rate than e.g., using a baseline model, and trying to train themselves. Secondly, existing RBSs can be retrained (e.g., periodically or in case of model drift/performance degradation), using “consultant” advice from other RBSs.

In another embodiment, there is provided a computer program product comprising a computer readable medium, the computer readable medium having computer readable code embodied therein, the computer readable code being configured such that, on execution by a suitable computer or processor, the computer or processor is caused to perform the method or methods described herein.

Thus, it will be appreciated that the disclosure also applies to computer programs, particularly computer programs on or in a carrier, adapted to put embodiments into practice. The program may be in the form of a source code, an object code, a code intermediate source and an object code such as in a partially compiled form, or in any other form suitable for use in the implementation of the method according to the embodiments described herein.

It will also be appreciated that such a program may have many different architectural designs. For example, a program code implementing the functionality of the method or system may be sub-divided into one or more sub-routines. Many different ways of distributing the functionality among these sub-routines will be apparent to the skilled person. The sub-routines may be stored together in one executable file to form a self-contained program. Such an executable file may comprise computer-executable instructions, for example, processor instructions and/or interpreter instructions (e.g. Java interpreter instructions). Alternatively, one or more or all of the sub-routines may be stored in at least one external library file and linked with a main program either statically or dynamically, e.g. at run-time. The main program contains at least one call to at least one of the sub-routines. The sub-routines may also comprise function calls to each other.

The carrier of a computer program may be any entity or device capable of carrying the program. For example, the carrier may include a data storage, such as a ROM, for example, a CD ROM or a semiconductor ROM, or a magnetic recording medium, for example, a hard disk. Furthermore, the carrier may be a transmissible carrier such as an electric or optical signal, which may be conveyed via electric or optical cable or by radio or other means. When the program is embodied in such a signal, the carrier may be constituted by such a cable or other device or means. Alternatively, the carrier may be an integrated circuit in which the program is embedded, the integrated circuit being adapted to perform, or used in the performance of, the relevant method.

Variations to the disclosed embodiments can be understood and effected by those skilled in the art in practicing the claimed invention, from a study of the drawings, the disclosure and the appended claims. In the claims, the word “comprising” does not exclude other elements or steps, and the indefinite article “a” or “an” does not exclude a plurality. A single processor or other unit may fulfil the functions of several items recited in the claims. The mere fact that certain measures are recited in mutually different dependent claims does not indicate that a combination of these measures cannot be used to advantage. A computer program may be stored/distributed on a suitable medium, such as an optical storage medium or a solid-state medium supplied together with or as part of other hardware, but may also be distributed in other forms, such as via the Internet or other wired or wireless telecommunication systems. Any reference signs in the claims should not be construed as limiting the scope.

1. A computer implemented method performed by a first network node in a communications network for training a first agent to select an action in order to perform a task according to a Reinforcement Learning, RL, process, the method comprising:
i) determining a first action using the first agent, based on a first state in the communications network;
ii) sending the first action and the first state to a second network node having a second agent;
iii) receiving from the second network node, feedback based on output from the second agent, on taking the first action when the communications network is in the first state; and
iv) using the feedback in the training of the first agent.

2. A method as in claim 1, wherein a first score representing a measure of a quality of previous feedback received from the second agent, is used to:
select the second agent to receive feedback from; and/or
determine whether to use the feedback in the training of the first agent.

3. A method as in claim 2, further comprising:
performing the first action;
comparing a first reward received as a result of the step of performing the first action, to the feedback from the second agent; and
setting the first score for the second agent based on the comparison, wherein the first score indicates whether the feedback received from the second agent is positively correlated with the reward.

4. (canceled)

5. A method as in claim 3, further comprising:
using the first score for the second agent to determine whether to send a second action and a second state to the second agent in order to obtain feedback from the second agent on taking the second action when the communications network is in the second state.

6. A method as in claim 3, further comprising:
sending the second action and the second state to a third agent in order to obtain feedback from the third agent on taking the second action when the communications network is in the second state, if a second score associated with the third agent indicates that the third agent is more likely to provide higher quality feedback than the first score associated with the second agent.

7. A method as in claim 1, wherein iv) using the feedback in the training of the first agent comprises:
changing an exploration strategy of the first agent based on the feedback.

8. A method as in claim 7, wherein changing the exploration strategy comprises:
reducing a first probability associated with the first agent selecting a subsequent action using an exploration strategy if the feedback from the second agent is positive; or
increasing a second probability associated with the first agent selecting a subsequent action using an exploration strategy if the feedback from the second agent is negative.

9. A method as in claim 1, wherein the feedback is based on a comparison between the first action and a third action, wherein the third action is determined by the second agent, based on the first state in the communications network.

10. A method as in claim 8, wherein the feedback is a distance metric between the first action and the third action in an action space.

11. A method as in claim 9, wherein the feedback indicates whether the third action determined by the second agent is the same as the first action determined by the first agent.

12. A method as in claim 9, wherein the feedback further comprises a confidence value indicating an extent to which the third action was determined using a policy action of the second agent or determined by an exploration of the action space.

13. A method as in claim 1, further comprising:
repeating steps i)-iii) for a plurality of other agents; and
wherein step iv) comprises:
using an aggregation of the feedback from the plurality of agents in the training of the first agent.

14. A method as in claim 1, wherein:
the second agent is for performing the same task as the first agent;
the second agent has undergone more training than the first agent; and/or
the second agent is more reliable than the first agent.

15. A method as in claim 1, wherein the action is to be performed by a mechanical entity interacting with a real-world environment; and wherein the first state comprises observations of the environment.

16. A method as in claim 15, wherein the task is related to maintenance of the mechanical entity, wherein the observations comprise one or more alarm statuses and the action comprises a prediction of a failure status.

17. A method as in claim 1 wherein, the state comprises measurements of key performance indicators, KPIs, in the communications network, the task is related to a failure of the communication network to achieve a target KPI, and the action comprises making a change in the operation or configuration of the communication network.

18. A method as in claim 1, wherein the state comprises measurements of key performance indicators, KPIs, in the communications network and the action comprises making a prediction of a congestion level.

19. A method as in claim 1, wherein the task is related to resource partitioning of network slices, the state comprises traffic volumes sent on different slices in the communications network and the action comprises selecting a manner in which to partition the spectrum.

20. A method as in claim 1, wherein the action changes a configuration parameter affecting the operation of the network.

21. A computer implemented method performed by a second network node in a communications network for training a first agent on a first network node in the communications network to select an action in order to perform a task according to a Reinforcement Learning, RL, process, the method comprising:
receiving from the first network node a first state in the communications network and a first action determined by the first agent for the first state; and
sending to the first node, feedback based on output from a second agent, on taking the first action when the communications network is in the first state.

22.-38. (canceled)
